(19) United States
(12) Patent Application Publication
(10) Pub. No.: US 2010/0232420 A1
(43) Pub. Date: Sep. 16, 2010

(54) COMMUNICATION APPARATUS AND RELATED METHOD

(76) Inventor: I-Hung Hung, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/723,675

(22) Filed: Mar. 14, 2010

(30) Foreign Application Priority Data
Mar. 16, 2009 (TW) 098108474

(51) Int. Cl. H04L 12/66; G10L 19/00

(52) U.S. Cl. 370/352; 704/201; 704/E19.001

(57) ABSTRACT

A communication apparatus includes a network interface, a voice processor, a data bus and a microprocessor. The voice processor includes a judging module and a voice codec module coupled with the judging module. The judging module is coupled with the network interface. The microprocessor is coupled with the voice-processor through the data bus. A packet-based local area connection is formed between the voice processor and the microprocessor. The network interface is used to receive a network resource message and a VoIP message. When the network resource message is received by the network interface and sorted by the judging module, the voice processor transfers the network resource message to the microprocessor through the local area connection. When the VoIP message is received by the network interface and sorted by the judging module, the judging module transmits the VoIP message to the voice codec module for further processing.

### BACKGROUND OF THE INVENTION

1. Field of the Invention

The present invention relates to communications apparatuses, and more particularly to a communication apparatus capable of simultaneously handling network resource messages and Voice over Internet Protocol (VoIP) messages and related method.

2. Description of the Prior Art

Currently, telephone communication is the most convenient mechanism for remote interpersonal communication, allowing real-time discussion or dialogue on personal or business matters. The most ubiquitous telephone system today is the Public Switched Telephone Network (PSTN), which has an enormous global user base. Connections between switchboards and telephone sets are normally realized through physical cables, either copper or fiber-optic. Simulated voice signals are further sampled and quantized into digital signals to aid in sending voice signals over digital switched transmission networks. The PSTN telephone system utilizes combinations of numbers, also known as a “telephone number”, to represent and address different users. The telephone number system typically distinguishes between local, long-distance, and international calls. Telephone service companies may then charge different calling rates according to different locations of a caller and a receiver. However, as telephone providers in each country charge users to use their respective telephone lines, long distance call rates are not lowered easily, and international rates are even more expensive.

Thus, after the arrival of Voice over Internet Protocol (VoIP) as a new form of telephone communication, the telephone system market began changing rapidly. VoIP uses the globally pervasive Internet as a medium for transmitting packetized data. As packet transmission can effectively utilize bandwidth of each line without downtime, and cost of connecting to the Internet is relatively low, VoIP telephone system rates may be greatly reduced compared to PSTN telephone system rates. Thus, VoIP is gaining widespread adoption by businesses that have high long-distance and international call volume. As packet transmission stabilization technology has steadily improved, the VoIP telephone system has steadily gained acceptance in the general marketplace.

Currently, an analog telephone adapter (ATA) for combining the VoIP and PSTN telephone networks is available. Please refer to FIG. 1, which is a diagram of an ATA 1 according to the prior art. As shown in FIG. 1, the ATA 1 comprises a network interface 10 for interfacing with external devices, a local area network interface 12 for interfacing with a local network, a PSTN interface 14 for external interfacing, and a second PSTN interface 16 for interfacing with a telephone set. Through the ATA 1, the user may utilize VoIP transmission through the network interface 10, or may make a phone call over the traditional switched telephone system through the PSTN interface 14. The ATA 1 may also be connected to the telephone set to provide an operation interface for receiving or placing calls, and may be connected to a personal computer (PC) for use as a router. However, the ATA 1 cannot operate individually as it lacks a control interface, but must be utilized through connection with the telephone set or the PC.

In practical use, many multimedia devices utilizing networks as a transmission medium also exist, including personal digital assistants (PDAs), smartphones, and netbooks, etc. These multimedia devices have network interfaces and embedded microprocessors. The embedded microprocessors are designed for low power consumption, and may be utilized for executing basic functions of embedded systems. In order to incorporate VoIP features in these multimedia devices, VoIP software is typically executed by the embedded systems of the multimedia devices for placing network calls through network interfaces. Thus, electronic devices are constructed that are capable of receiving and sending all kinds of network resources and also placing calls.

However, design of these embedded microprocessors is performed based on many types of signal processing, such as graphics, keyboard input, and arithmetic/logic processing, etc. If the embedded microprocessor utilizes software to simulate VoIP codecs as a method to provide the necessary arithmetic functions required for VoIP, the embedded microprocessor of the multimedia device may not be powerful enough.

### SUMMARY OF THE INVENTION

According to an embodiment, a multiplex communication apparatus comprises a network interface for receiving a network resource message and a Voice over Internet Protocol (VoIP) message, a voice processor, a data bus, and a microprocessor coupled to the voice processor through the data bus. The voice processor comprises a judging module electrically connected to the network interface, and a voice codec module electrically connected to the judging module. The voice processor and the microprocessor establish a local area connection for transmitting data in packet form according to a network communications protocol.

According to the embodiment, a method of performing multiplex communication is utilized in a multiplex communication apparatus comprising a voice processor, a microprocessor, and a network interface. The voice processor is electrically connected to the network interface, and the network interface is utilized for receiving a network message. The method comprises the voice processor identifying the network message received by the network interface, the voice processor executing a first socket program, the microprocessor executing a second socket program, and establishing a local area connection between the voice processor and the microprocessor through the first socket program and the second socket program. The local area connection utilizes packets as a transmission medium according to a network communication protocol. The method further comprises the voice processor sending the network message to the microprocessor through the local area connection when it is determined that the network message received by the network interface is a network resource message, and the voice processor performing voice processing on the network message when it is determined that the network message received by the network interface is a Voice over Internet Protocol (VoIP) message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an ATA according to the prior art.

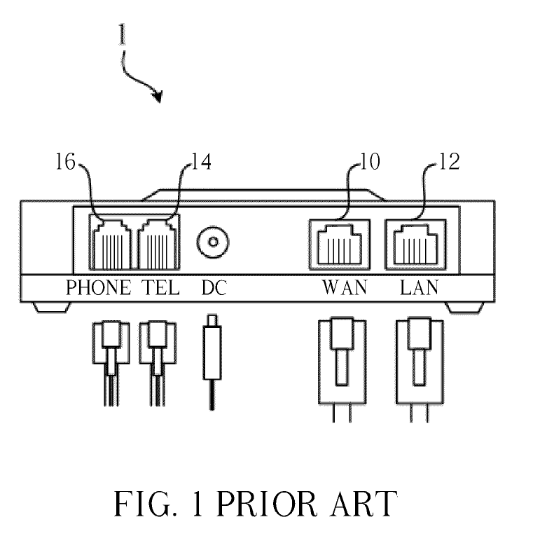

FIG. 2 is a function block diagram of a multiplex communication apparatus according to a first embodiment.

FIG. 3 is a diagram illustrating signal transmission of the multiplex communication apparatus of FIG. 2.

FIG. 4 is a function block diagram of a multiplex communication apparatus according to a second embodiment.

FIG. 5 is a flowchart illustrating a process for performing multiplex communication according to a third embodiment.

FIG. 6 is a diagram illustrating execution of a socket program and local area connection procedures in the process of FIG. 5.

### DETAILED DESCRIPTION

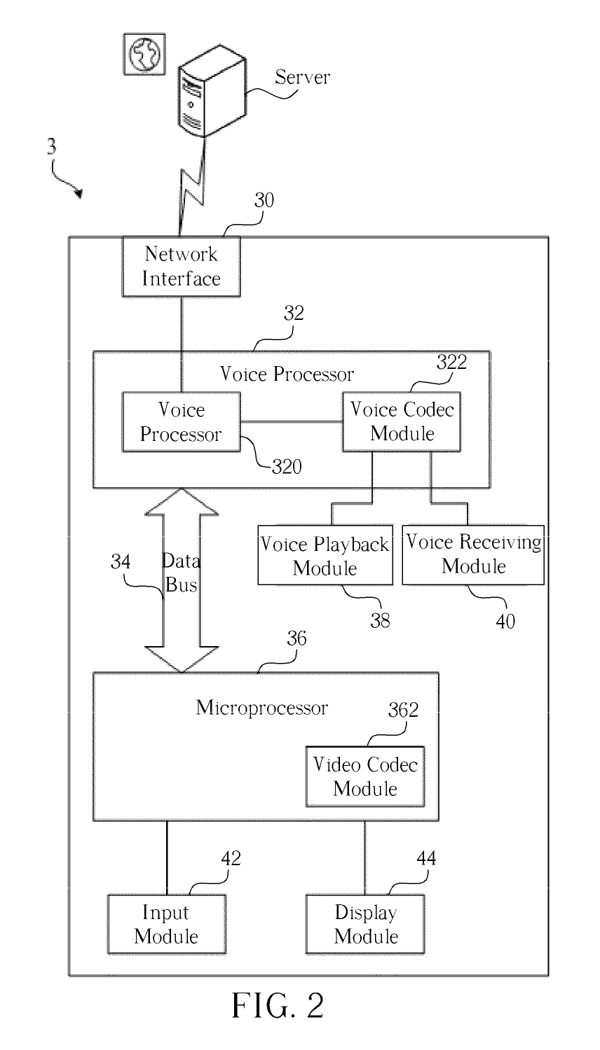

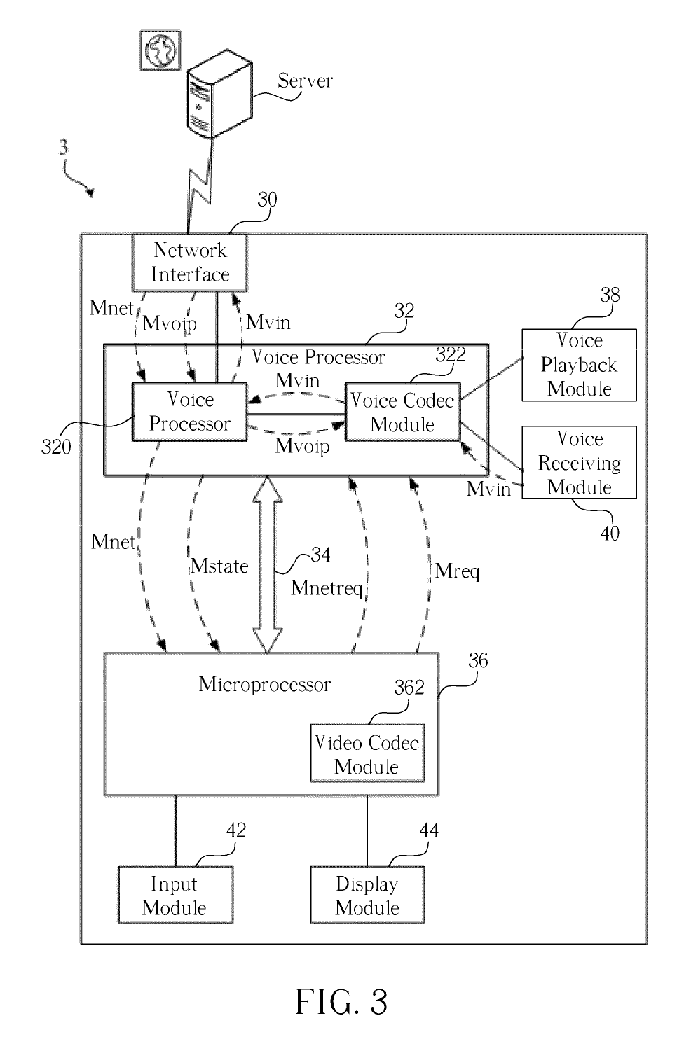

Please refer to FIG. 2 and FIG. 3. FIG. 2 is a function block diagram of a communication apparatus 3 according to a first embodiment. FIG. 3 is a diagram illustrating signal transmission of the communication apparatus 3 of FIG. 2. As shown in FIG. 2, the communication apparatus 3 may comprise a network interface 30, a voice processor 32, a data bus 34, a microprocessor 36, a voice playback module 38, a voice receiving module 40, an input module 42, and a display module 44.

The voice processor 32 may comprise a judging module 320 and a voice codec module 322. The judging module 320 may be electrically connected to the network interface 30. The voice codec module 322 may be electrically connected to the judging module 320. The voice playback module 38 and the voice receiving module 40 may be electrically connected to the voice codec module 322.

The microprocessor 36 may be electrically connected to the voice processor 32 through the data bus 34. The input module 42 may be electrically connected to the microprocessor 36. The microprocessor 36 may comprise a video codec module 362. The display module 44 may be electrically connected to the microprocessor 36.

In some embodiments, the network interface 30 may be utilized for establishing a data connection with a network server Server. The network interface 30 may be a Digital Subscriber Line (DSL) or cable wide area network (WAN) connection interface, though limitation to these two types of connection interface is not intended. The network interface 30 may be utilized for receiving a network message, such as a network resource message Mnet or a Voice over Internet Protocol (VoIP) message Mvoip.

The voice processor 32 may comprise a VoIP system integrated circuit (IC). The judging module 320 of the voice processor may receive the network resource message Mnet and the VoIP message Mvoip from the network interface 30, and may identify the network message as the network resource message Mnet and the VoIP message Mvoip. The judging module 320 may function similar to a router, sorting the two different types of network messages received from the network interface 30. When the judging module 320 determines that the network message received from the network interface 30 is a network resource message Mnet, the voice processor 32 may send the network resource message Mnet to the microprocessor 36 through the local area connection.

The above-described method of transmitting data between the voice processor 32 and the microprocessor 36 may include establishing a local area connection based on packets as a transmission medium between the voice processor 32 and the microprocessor 36. In practical implementation of a hardware layer, packets may be sent through the data bus 34 connecting the voice processor 32 to the microprocessor 36. The local area connection may conform to a network communications protocol, which may be a User Datagram Protocol (UDP) or a Transmission Control Protocol (TCP) in some embodiments. Type of the network communications protocol employed in the local area connection is not limited to UDP or TCP.

The data bus 34 may act as a physical line connecting the voice processor 32 to the microprocessor 36. In some embodiments, the data bus 34 may be a pulse-code modulation (PCM) bus, without limit thereto.

In some embodiments, the microprocessor 36 may execute a low-power processing module of an embedded operating system (OS), which may be a Windows CE, embedded Linux, or Palm OS. The microprocessor 36 may provide general user functions, such as online services, web browsing, and word processing, etc. When the voice processor 32 sends the network resource message Mnet to the microprocessor 36 through the local area connection, the microprocessor 36 may process the network resource message Mnet. For example, if the network resource message Mnet comprises multimedia webpage data, the microprocessor 36 may utilize the video codec module 362 to display the multimedia webpage data in the display module 44.

When the user desires to actively obtain online information, e.g. when the user discovers an interesting link, the user may operate the input module 42, which may be a keyboard, mouse, or button, or a touchscreen installed on the display module 44. The microprocessor 36 may generate a network request message Mnetreq based on the operation of the input module 42. The microprocessor 36 may output the network request message Mnetreq to the voice processor 32 through the local area connection, and further output the network request message Mnetreq through the network interface 30, such that the communication apparatus 3 may perform Internet functions.

Please note that the voice processor 32 and the microprocessor 36 may execute a socket program to generate packets. Transmitting messages in this way across the local area connection allows for greater programmability of data transmission between the voice processor 32 and the microprocessor 36. For example, in some embodiments, the microprocessor 36 may run embedded browser software, such as Internet Explorer, set object code, such as Active X, in the embedded browser software, and utilize an object control language, such as JavaScript, to control application of the software program. In this way, an application layer of the voice processor 32 and the microprocessor 36 may have greater flexibility, and may not require changes to hardware circuits every time minor application updates are made.

When the judging module 320 of the voice processor 32 identifies the network message as the VoIP message Mvoip, the judging module 320 may send the VoIP message Mvoip to the voice codec module 322 for processing. After the voice codec module 322 processes the VoIP message Mvoip to obtain audio data, the audio data may be played through the voice playback module 38. The voice receiving module 40 may receive an input voice message Mvin, which may be outputted through the network interface 30 after processing by the voice codec module 322. In this way, VoIP functions may be performed by the communication adapter 3.

The voice processor 32 may generate a status message Mstate corresponding to the VoIP message Mvoip, and may send the status message Mstate to the microprocessor 36 through the local area connection. The status message Mstate may be transmitted in packet form. Information recorded in the packet of the status message Mstate may comprise packet length, a status content, at least one status parameter, a sequence number, and a checksum. In some embodiments, the status content may correspond to network use status, network server status, call status, standby status, and/or ringing status. The status parameter may be information corresponding to the status content. For example, the at least one status parameter corresponding to the ringing status may be caller identification information and/or information on current number and/or duration of rings. The microprocessor 36 may determine condition of the VoIP call of the communication apparatus 3 through the status content and the at least one status parameter, and may display the status information in the display module 44 to inform the user. Other fields, such as the packet sequence number and checksum, are well known settings for VoIP in the art, and are not explained further herein.

When the user desires to actively hang up, place a call, or execute VoIP-related functions, the user may operate the input module 42. The microprocessor 36 may generate a request message Mreq based on the operation of the input module 42, and may send the request message Mreq to the voice processor 32 through the local area connection. The judging module 320 of the voice processor 32 may execute a VoIP function corresponding to the request message Mreq.

The request message Mreq may be transmitted in packet format. A packet of the request message Mreq may record information comprising packet length, a request content, at least one request parameter, a sequence number, and a checksum. The request content may correspond to an answer request, a hang up request, a dial request, a volume adjustment request, or a call record request. The at least one request parameter may comprise information corresponding to the request content. For example, when the request content is the dial request, the request parameter may comprise such information as a phone number to be dialed and/or a network address, etc. In this way, the user may operate the input module 42 of the communication apparatus 3 to make various VoIP requests.

In some embodiments, the communication apparatus 3 may combine general network browsing functions and communications functions, such that the voice processor 32 and the microprocessor 36 may interact to provide application functions. For example, when the user may be browsing a multimedia advertisement, and may become interested in a product, the user may directly press a button or location on a touchscreen of the input module 42 corresponding to the product, the microprocessor 36 may generate a request message Mreq comprising vendor information of the product based on the operation of the input module 42, the microprocessor 36 may send the request message Mreq to the voice processor 32, and the voice processor 32 may dial a phone number of the vendor. When voice call is set up between the user and the vendor, the user may directly order the product from the vendor, request service, or ask for information about the product.

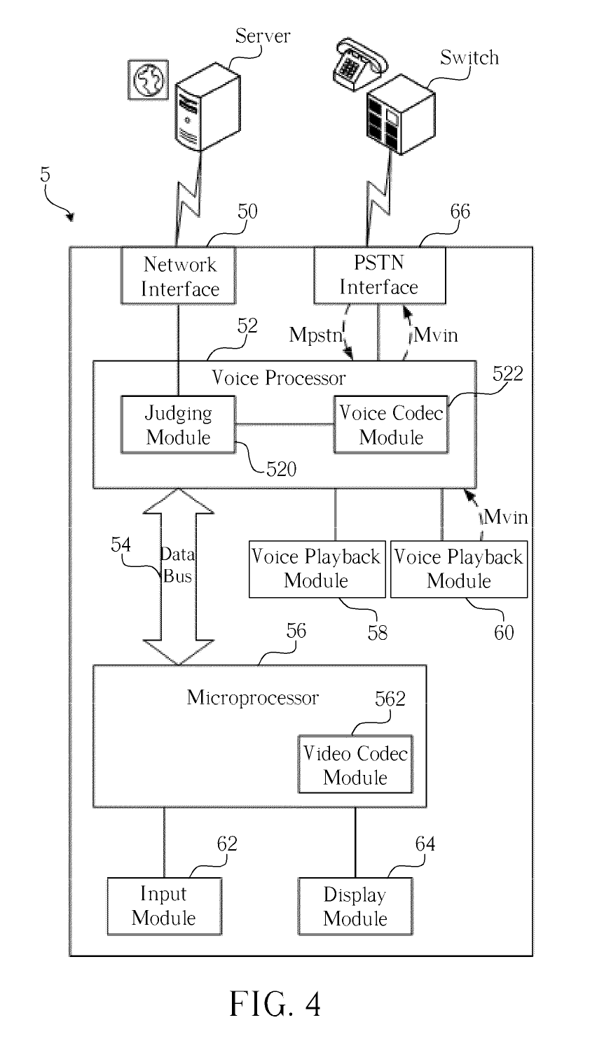

Please refer to FIG. 4, which is a function block diagram of a communication apparatus 5 according to a second embodiment. As shown in FIG. 4, the communication apparatus 5 may be different from the communication apparatus 3 in that the communication apparatus 5 may comprise a PSTN interface 66. The PSTN interface 66 may be utilized for connecting with a telephone switchboard Switch. A voice processor 52 may be electrically connected to the PSTN interface 66, and may receive a PSTN message Mpstn through the PSTN interface 66. A voice playback module 58 may be electrically connected to a voice processor 52, and may be utilized for playing content of the PSTN message Mpstn. A voice receiving module 60 may be electrically connected to the voice processor 52, and may receive an input voice signal Mvin and output the input voice signal Mvin through the PSTN interface 66 to perform telephone communication functions.

In some embodiments, the voice processor 52 may comprise an integrated VoIP and PSTN integrated circuit (IC). The communication apparatus 5 may selectively utilize the VoIP circuit block and/or the PSTN circuit block to perform voice communication.

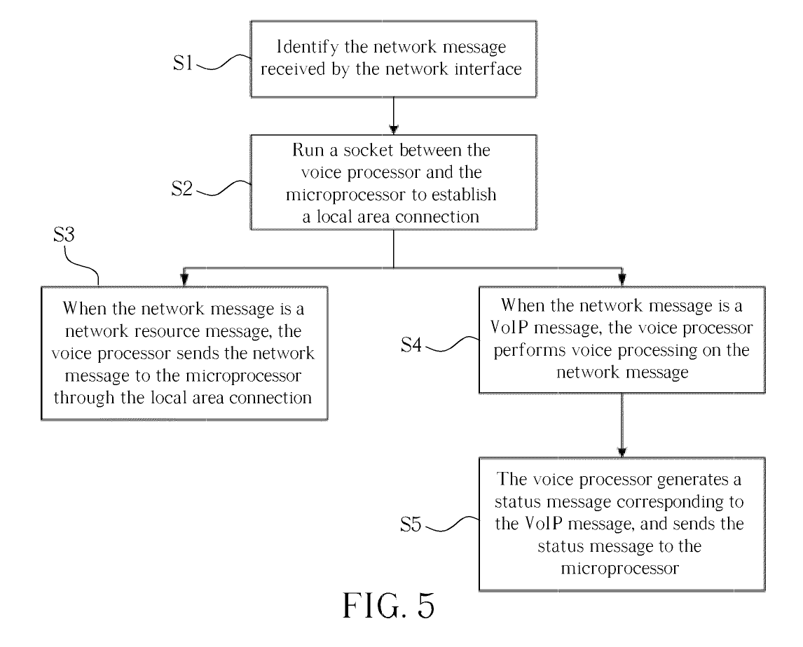

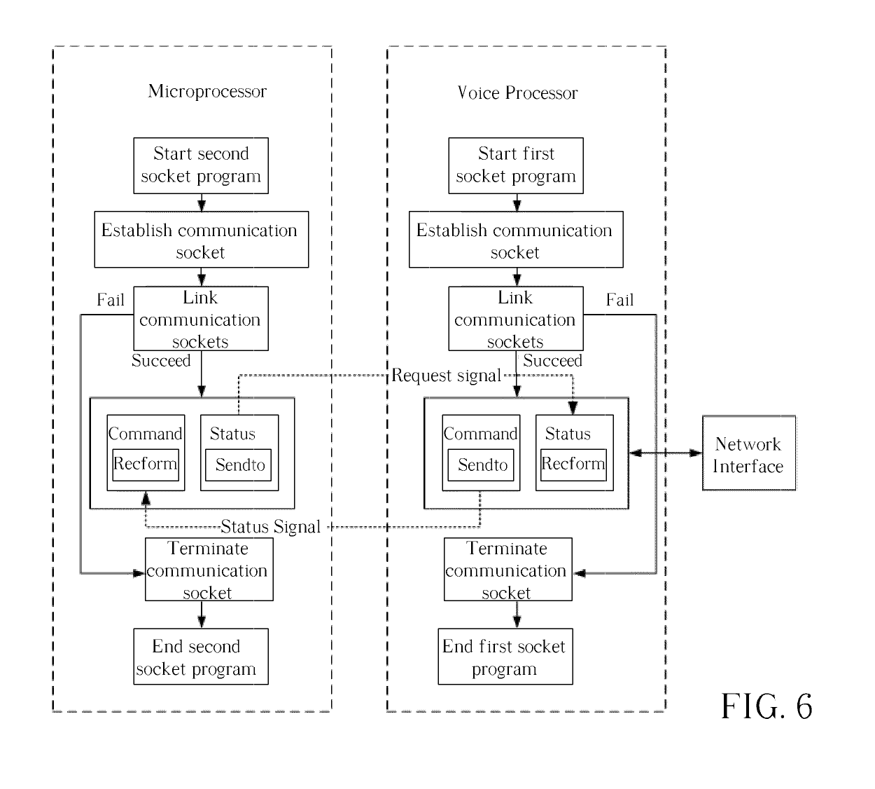

Please refer to FIG. 5 and FIG. 6. FIG. 5 is a flowchart illustrating a process 50 for performing multiplex communication according to a third embodiment. FIG. 6 is a diagram illustrating execution of a socket program and local area connection procedures in the process 50 of FIG. 5. The process 50 for performing multiplex communication may be suitable for use in a communication apparatus. Please refer also to FIG. 2 for detailed description of internal hardware and electrical connections thereof of the communication apparatus, which will not be reiterated in the following description of the process 50.

In some embodiments, the communication apparatus may receive network messages through a network interface. The process 50 may begin with a voice processor identifying the network message received by network interface (Step S1). Then, the voice processor may run a first socket program and a microprocessor may run a second socket program to establish a local area connection between the voice processor and the microprocessor through the first socket program and the second socket program.

The local area connection may be established according to a network communication protocol, and may utilize packets as a transmission medium. The local area connection establishes communication sockets through the first socket program and the second socket program, respectively. In some embodiments, the communication sockets may utilize ports 2251 and 2252. The communication sockets may verify each other, and after linking up, may establish a UDP or TCP connection, through which the voice processor and the microprocessor may send messages to each other, as shown in FIG. 6.

When the network message received by the network interface is determined in Step S1 to be a network resource message, the communication process 50 may proceed to Step S3. The voice processor may send the network message to the microprocessor through the local area connection, and the microprocessor may perform further processing and judging.

When the network message received is identified as the VoIP message in Step S1, the communication process 50 may proceed to Step S4. The voice processor may be utilized to perform voice processing on the network message, and in some embodiments, the voice processor may comprise a corresponding voice codec module for handling network voice functions, e.g. VoIP. Then, the voice processor may be utilized to generate a corresponding status signal of the VoIP message, and the status message may be sent to the microprocessor through the local area network (Step S5). The status message may be sent as a packet comprising a packet length, a status content, at least one status parameter, a sequence number, and a checksum. The status content may correspond to a line in use status, a network server status, a call status, a standby status, or a ringing status.

When the user operates the communication apparatus due to an application requirement, the microprocessor may respond to a request entered by the user. In some embodiments, the multiplex communication process 50 may drive the microprocessor to generate a request message according to the operation of the user. The request message may be sent to the voice processor through the local area connection.

The request message may be sent as a packet comprising a packet length, a request content, at least one request parameter, a sequence number, and a checksum. The request content may correspond to an answer request, a hang up request, a dial request, a volume adjustment request, or a call record request.

The communication apparatus described in the above embodiments has both a microprocessor for handling network resource messages, and a voice processor for handling VoIP messages, allowing the user to obtain all types of online resources while also providing network telephoning functions through a connection to an external network. Please note that the embodiments described utilize an internal local area connection to perform signal communication between the voice processor and the microprocessor, and may utilize a socket program to generate packets as a transmission medium that comply with requirements of both the video processor and the microprocessor, making signal switching between the voice processor and the microprocessor more programmable.

Overall, the communication apparatus described in the above embodiments allows for network applications unavailable in traditional network telephone sets, and solves the problem of traditional networked multimedia devices that are unable to provide network calling functions due to insufficient processing power. The communication apparatus, which may perform multiplex processing through the voice processor and the microprocessor, may be utilized for networked voice communication applications, as well as other common network resource applications, and is suitable for all types of mixed voice communication/network resource environments, such as multimedia interactive advertising and video conferencing.

Those skilled in the art will readily observe that numerous modifications and alterations of the device and method may be made while retaining the teachings of the invention.

What is claimed is:

1. A communication apparatus comprising:
a network interface for receiving a network resource message and a Voice over Internet Protocol (VoIP) message;
a voice processor comprising:
a judging module electrically connected to the network interface; and
a voice codec module electrically connected to the judging module;
a data bus; and
a microprocessor coupled to the voice processor through the data bus;
wherein the voice processor and the microprocessor establish a local area connection for transmitting data in packet form according to a network communications protocol.

2. The communication apparatus of claim 1, wherein when the voice processor receives the VoIP message from the network interface, the voice processor generates a status message corresponding to the VoIP message, and sends the status message to the microprocessor through the local area connection.

3. The communication apparatus of claim 2, wherein the status message is sent as a packet, the packet comprises a packet length, a status content, a status parameter, a sequence number, and a checksum, and the status content corresponds to a connection use status, a network server status, a call status, a standby status, or a ringing status.

4. The communication apparatus of claim 1, further comprising a voice playback module and a voice receiving module, each electrically connected to the voice codec module, the voice playback module utilized for playing back processed content of the VoIP message processed by the voice codec module, the voice receiving module utilized for receiving an input voice signal, and the input voice signal outputted through the network interface after being processed by the voice codec module to perform a VoIP function.

5. The communication apparatus of claim 1, further comprising a public switching telephone network (PSTN) interface electrically connected to the voice processor, wherein the voice processor is configured to receive a telephone message through the PSTN interface.

6. The communication apparatus of claim 5, further comprising a voice playback module and a voice receiving module, each electrically connected to the voice processor, the voice playback module utilized for playing back content of the telephone message, the voice receiving module utilized for receiving an input voice signal and outputting the input voice signal through the PSTN interface to perform a telephoning function.

7. The communication apparatus of claim 5, wherein the voice processor comprises an integrated VoIP and PSTN integrated circuit (IC).

8. The communication apparatus of claim 1, wherein the microprocessor is configured for executing a Windows CE, Linux, or Palm OS embedded operating system.

9. The communication apparatus of claim 1, further comprising a display module electrically connected to the microprocessor, wherein the microprocessor further comprises a video codec module, and when the microprocessor receives the network resource message from the voice processor through the network local area connection, the microprocessor utilizes the video codec module to display the network resource message on the display module.

10. The communication apparatus of claim 1, further comprising an input module electrically connected to the microprocessor, wherein the microprocessor is configured to generate a network request message according to operation of the input module, send the network request message to the voice processor through the local area connection, and output the network request message through the network interface.

11. The communication apparatus of claim 1, further comprising an input module electrically connected to the microprocessor, wherein the microprocessor is configured to generate a request signal according to operation of the input module, and send the request signal to the voice processor through the local area connection.

12. The communication apparatus of claim 11, wherein the request signal is sent as a packet comprising a packet length, a request content, a request parameter, a sequence number, and a checksum, the request content corresponding to an answer request, a hang up request, a dial request, a volume adjust request, or a call record request.

13. The communication apparatus of claim 1, wherein the network communications protocol is User Datagram Protocol (UDP) or Transfer Control Protocol (TCP).

14. The communication apparatus of claim 1, wherein the voice processor and the microprocessor each execute a socket program to generate the packet.

15. A method of performing multiplex communication utilized in a communication apparatus comprising a voice processor, a microprocessor, and a network interface, the voice processor electrically connected to the network interface, the network interface utilized for receiving a network message, the method comprising:
the voice processor identifying the network message received by the network interface;
the voice processor executing a first socket program, the microprocessor executing a second socket program, and establishing a local area connection between the voice processor and the microprocessor through the first socket program and the second socket program, wherein the local area connection utilizes packets as a transmission medium according to a network communication protocol;
the voice processor sending the network message to the microprocessor through the local area connection when it is determined that the network message received by the network interface is a network resource message; and
the voice processor performing voice processing on the network message when it is determined that the network message received by the network interface is a Voice over Internet Protocol (VoIP) message.

16. The method of claim 15, wherein when it is determined that the network message received by the network interface is the VoIP message, the step of the voice processor performing voice processing on the network message comprises:
utilizing the voice processor to generate a status message corresponding to the network message; and
sending the status message to the microprocessor through the local area connection.

17. The method of claim 16, wherein the status message is sent as a packet comprising a packet length, a status content, a status parameter, a sequence number, and a checksum, the status content corresponding to a network use status, a network server status, a call status, a standby status, or a ringing status.

18. The method of claim 15, further comprising:
the microprocessor generating a request signal; and
sending the request signal to the voice processor through the local area connection.

19. The method of claim 18, wherein the request signal is sent as a packet comprising a packet length, a request content, a request parameter, a sequence number, and a checksum, the request content corresponding to an answer request, a hang up request, a dial request, a volume adjust request, or a call record request.
